(19) United States
(12) Patent Application Publication
(10) Pub. No.: US 2019/0021012 A1
(43) Pub. Date: Jan. 17, 2019

(54) METHOD AND SYSTEM FOR RF PLANNING IN A DYNAMIC SPECTRUM ENVIRONMENT

(71) Applicant: CommScope Technologies LLC, Hickory, NC (US)

(72) Inventors: Andrew E. Beck, Ashburn, VA (US); Ariful Hannan, Sterling, VA (US); Thomas B. Gravely, Herndon, VA (US)

(73) Assignee: CommScope Technologies LLC, Hickory, NC (US)

(21) Appl. No.: 15/989,026

(22) Filed: May 24, 2018

Related U.S. Application Data
(60) Provisional application No. 62/531,505, filed on Jul. 12, 2017.

(51) Int. Cl. H04W 16/18; H04W 16/16; H04W 24/06; H04W 24/02

(52) U.S. Cl. CPC H04W 16/18; H04W 24/02; H04W 24/06; H04W 16/16

(57) ABSTRACT

A system is provided. The system comprises a radio frequency (RF) planning system, comprising: a first processing system; a first communications system coupled to the first processing system; at least one input/output device coupled to the first processing system; wherein the first processing system comprises first memory circuitry and first processor circuitry; and wherein the first processing system is configured to: receive proposed RF access system design criteria; synthesize an RF access system design; assess interference using shared spectrum system data and data about the synthesized RF access system design; determine if the proposed RF access system design criteria are acceptable based upon the interference assessment; and if the proposed RF access system design criteria are unacceptable, then adjust the proposed RF access system design criteria.

### CROSS-REFERENCE TO RELATED APPLICATIONS

The present application claims benefit of U.S. Patent Application Ser. No. 62/531,505, filed Jul. 12, 2017; the entire content of the aforementioned patent application is incorporated herein by reference as if set forth in its entirety.

### BACKGROUND

Conventional communications networks in licensed frequency spectrum (or spectrum) are designed using radio frequency (RF) planning tools to ensure satisfactory operation. In such licensed frequency spectrum, frequency bands are divided among wireless service providers with typically one provider occupying a given band of spectrum. As a result, the information required for network planning is readily accessible.

Shared spectrum usage by governmental and commercial users has been proposed, and is expected to be deployed in the future. With shared spectrum usage, a multitude of wireless service providers, known and/or unknown, to a network planner would utilize such spectrum. As a result, planning a network in such a shared spectrum is significantly more complex. Therefore, there is a need for an RF planning tool to design communications networks for such shared spectrums.

### SUMMARY OF THE INVENTION

A system is provided. The system comprises a radio frequency (RF) planning system, comprising: a first processing system; a first communications system coupled to the first processing system; at least one input/output device coupled to the first processing system; wherein the first processing system comprises first memory circuitry and first processor circuitry; and wherein the first processing system is configured to: receive proposed RF access system design criteria; synthesize an RF access system design; assess interference using shared spectrum system data and data about the synthesized RF access system design; determine if the proposed RF access system design criteria are acceptable based upon the interference assessment; and if the proposed RF access system design criteria are unacceptable, then adjust the proposed RF access system design criteria.

### DRAWINGS

FIG. 1A illustrates one embodiment of a citizens broadband radio service system;

FIG. 1B illustrates one embodiment of a radio frequency (RF) planning system coupled to a spectrum access system;

FIG. 2 illustrates one embodiment of an RF planning system;

FIG. 3 illustrates one embodiment of a spectrum access system; and

FIG. 4 illustrates one embodiment of a method of cooperative operation between an RF planning system and a spectrum access system.

### DETAILED DESCRIPTION

An example of a shared spectrum system is the proposed Citizens Broadband Radio Service (CBRS) specified by the United States Federal Communications Commission (FCC). Subsequently, shared spectrum systems will be exemplified as CBRS systems for pedagogical reasons. However, the techniques proposed herein are applicable to any shared spectrum system. Further, wherever the term citizens broadband radio service device (CBSD) is used hereafter, it is an example of a radio frequency (RF) access system, or more generally a radio. In one embodiment, an RF access system is a base station, access point, or any other type of radio.

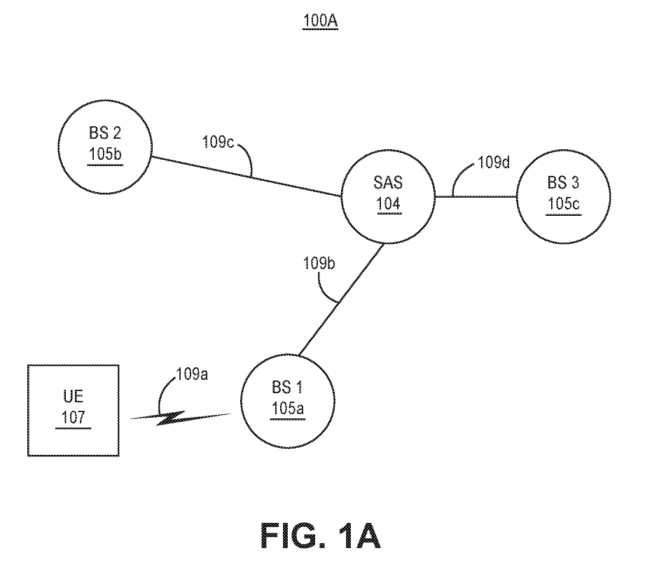

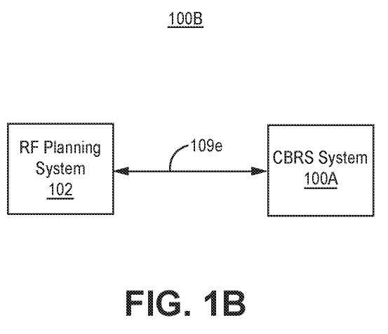

CBSDs may be deployed by one or more wireless service providers using frequency spectrum that is shared between devices. FIG. 1A illustrates one embodiment of a CBRS system 100A. The illustrated CBRS system 100A comprises a spectrum access system (SAS) 104 coupled to a first base station (BS 1) 105a, a second base station (BS 2) 105b, and a third base station (BS 3) 105c. The base stations may be base stations such as eNodeBs or access points.

The SAS 104 controls or regulates access to a frequency spectrum and will be subsequently described in more detail. User equipment 107, e.g. a portable device such as a handset, a phablet, a tablet or a laptop, wirelessly communicates with the first base station 105a over a first communications link 109a using a portion of the spectrum controlled by the SAS 104. For purposes of clarity, the term ‘user’ used in ‘user equipment’ refers to a user that is different than the user of the subsequently mentioned RF planning system, a general authorized (GAA) user, and an incumbent user.

The first base station 105a, the second base station 105b, and the third base station 105c are respectively coupled to the SAS 104 by a second communications link 109b, a third communications link 109c, and a fourth communications link 109d. Such communications systems may be any type of wireless and/or wired communications networks, e.g. a WiMAX communications network, an optical fiber communications network, and/or Ethernet communications network. Each base station, for example, is a CBSD.

FIG. 1B illustrates one embodiment of a radio frequency (RF) planning system coupled to a CBRS system (coupled systems) 100B. The RF planning system 102 can be used to design a proposed CBSD, or a proposed group or network of CBSDs, that would comprise or become part of the CBRS system 100A. The SAS 104 is coupled to the RF planning system 102 by a fifth communications link 109e. In another embodiment, the fifth communications link 109e is the Internet. However, alternatively, the fifth communications link 109e can be any wired and/or wireless communications link(s), e.g. a WiMAX communications network, an optical fiber communications network and/or an Ethernet based cable network.

The RF planning system 102 facilitates the design of proposed CBSD(s). When the proposed CBSD(s) are implemented, the SAS 104 would control the operating time, transmit power level, modulation type (e.g. corresponding to different data rate), and/or operating frequency spectrum of each such proposed CBSD.

The SAS 104 may control numerous other CBSDs and their same operational characteristics as exemplified herein. The CBSDs comprise communications systems, e.g. radios, of priority access licensees (PALs) and general authorized access users, and are managed by the SAS 104 to avoid interference to incumbent users, PALs, and/or GAA users.

Incumbent users have first, or highest, priority to utilize the frequency spectrum (or spectrum) controlled by the SAS 104. Thus, incumbent users shall be able to operate free of interference from other users, e.g. communications systems of priority access licensees and general authorized access users. Free of interference as used herein does not mean an absence of interference, but rather means an acceptable level of interference which may be no interference or a finite level of interference. The acceptable level of interference may vary by geography, frequency spectrum, user type, license type, and/or other indicia. In one embodiment, the incumbent users include government entities operating systems such as communications systems, operators of fixed satellite communications systems, and grandfathered, prior licensees of the spectrum. Communications systems, as used herein, shall include RADAR systems.

In one embodiment, PALs have second (or intermediate) priority, after incumbent users, to utilize the frequency spectrum controlled by the SAS 104. In another embodiment, a PAL shall be able to operate, when incumbent users are free of interference of such a PAL, free of interference from other priority access licensees and general authorized access users. In one embodiment, an ability of a PAL to operate free of interference shall be limited temporally, geographically, and spectrally within the specifications of its license.

General authorized access users shall have third, or lowest, priority to utilize the frequency spectrum controlled by the CBRS system 100A, e.g. the SAS 104. In one embodiment, an operation of GAA users will be governed by rules pertaining to the CBRS system 100A, e.g. established by governmental(s) and/or standards bodies. For example, such rules shall only let GAA users communications systems operate when they do not interfere with communication systems of incumbent users and PALs. Also, for example, such rules shall only let a GAA user's communications system operate as long as it does not interfere with another GAA user's communications system authorized to operate at the same time in the shared frequency spectrum controlled by the CBRS system 100A. As will be subsequently discussed, some GAA users may have priority over other GAA users.

In one embodiment, the geographic coverage area proximate to the CBRS system 100A may include exclusion zones and protection zones (including grandfathered wireless protection zones). CBSDs are prohibited from operating in specific frequency spectrum in exclusion zones. Further, the level of interference generated by, e.g. by all non-government users and even some government users (including incumbent users, PALs and GAA users) shall be limited in a protection zone so as not to interfere with certain incumbent users' communications systems such as RADARs. CBSDs may only operate with the permission of the SAS 104 when an incumbent user's communication system is operating in a protection zone. In some cases, this operation will be based upon information received by an environmental sensing capability (ESC) system, from external database(s), notification from an incumbent user, and/or from a beacon (which will be subsequently described). One type of protection zone is the grandfathered wireless protection zone which is a geographic area and/or frequency spectrum where grandfathered wireless broadband licensees can operate free of interference, e.g. of CBSDs.

The CBRS system 100A will be subsequently described in more detail. However, because of the aforementioned complexities of a SAS 104, the RF planning system 102 is coupled to the CBRS system 100A, e.g. the SAS 104, and operates in conjunction with the CBRS system 104, e.g. the SAS 104. As a result, the RF planning system 102 can obtain information from the CBRS system 100A, e.g. the SAS 104, about other radio systems (e.g. other CBSD(s)), protection zones, and exclusion zones which can be used to design proposed CBSD(s). In one embodiment, the RF planning system 102 relies upon the SAS 104 to perform analysis as will be subsequently exemplified. Using such information, the RF planning system 102, in conjunction with the CBRS system 100A, e.g. the SAS 104, can design proposed CBSD(s) that will cooperatively operate as part of the CBRS system 100A.

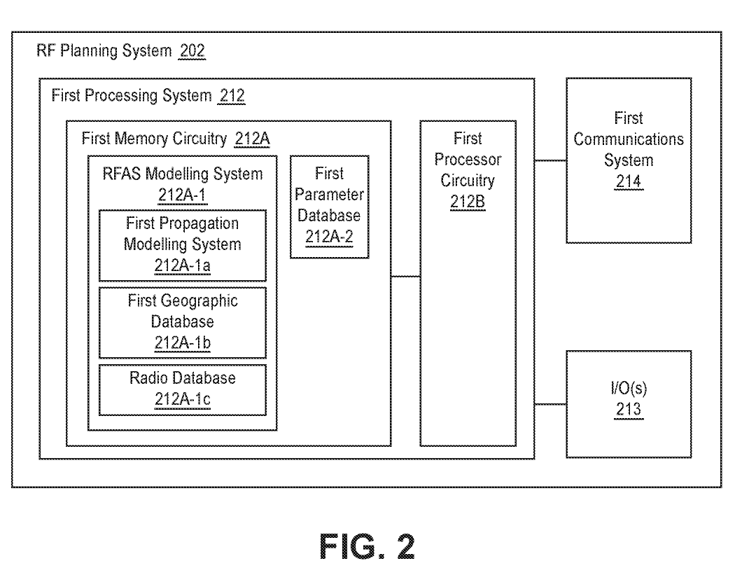

FIG. 2 illustrates one embodiment of an RF planning system 202. The illustrated RF planning system 202 comprises a first processing system 212 coupled to a first communications system 214. Optionally, the first processing system 212 is coupled to at least one input/output device (I/O(s)) 213. The first processing system 212 principally performs the RF planning function, e.g. the design of CBSD(s) in a CBRS system. The first communications system 214 facilitates communications between the first processing system 212 and external systems, e.g. the CBRS system 100A and it's the SAS 104, and/or remote user(s) of the RF planning system 202. Such remote user(s) are located at a distance from the RF planning system 202, and may be person(s) and/or computer system(s).

In one embodiment, the I/O(s) 213 allow a user, such as a person, to interact with the RF planning system 202, and may be a keyboard, a mouse, a joystick, a microphone and a voice recognition system, a touch screen display, a non-touch screen display (e.g. an LCD or OLED display), and/or a speaker and/or a voice synthesizer. In another embodiment, the RF planning system communications system 214 is an Internet modem, and/or any other communications device that can facilitate communications over the fifth communications link 109e with the CBRS system 100A (e.g. the SAS 104).

In the illustrated embodiment, the first processing system 212 includes first processor circuitry 212B coupled to first memory circuitry 212A. In the illustrated embodiment, the first memory circuitry 212A includes an RF access system (RFAS) modelling system 212A-1 and a first parameter database 212A-2. In the illustrated embodiment, the RFAS modelling system 212A-1 includes a first propagation modeling system 212A-1a, a first geographic database 212A-1b, and a radio database 212A-1c.

The first geographic database 212A-1b includes models of geographic terrain (e.g. terrain morphology and/or terrain elevation) and obstacles (such as large buildings), including in the geographic area where the proposed CBSD(s) are to be deployed. Such information may be obtained from external database(s), e.g. located at the U.S. Geological Survey. In one embodiment, the first geographic database 212A-1b includes the same information for the geographic area where the CBRS system 100A is located, and/or surrounding regions, e.g. where exclusion and/or protection zones, and/or other CBRS systems are located.

The radio database 212A-1c includes models of different types of transmitters, receivers, and/or antennas used to construct proposed CBSD(s). In one embodiment, a user selects all or some components from the radio database 212A-1c to be used in the proposed CBSD(s). Alternatively or additionally, e.g. if authorized by the user, the CBSD modelling system 212A-1 selects all or some components from the radio database 212A-1c to be used in the proposed CBSD(s), e.g. based upon proposed CBSD design criteria provided by the user. In another embodiment, transmitter operating band, maximum power level within such operating band, and/or relative out of band power levels are provided in the transmitter models. In a further embodiment, receiver operating band, sensitivity, and/or intermodulation distortion performance within such operating band are provided in the receiver models. In yet another embodiment, radiation pattern data (including gain, radiation polarization, radiation angle, antenna height, azimuthal angle, tilt angle, and/or ground plane) are provided in the antenna models. Alternatively, the SAS 104 may incorporate the radio database 212A-1c, and the corresponding information would be accessed from the SAS 104.

The first propagation modelling system 212A-1a estimates electromagnetic energy radiated by an antenna (coupled to a transmitter) at geographic location(s) and/or over geographic region(s). The first propagation modelling system 212A-1a includes one or more types of RF propagation models, which describe path loss, over geographic region, of a combination of a transmitter and antenna(s) for different propagation conditions. The selection of a propagation model depends upon frequency spectrum, the propagation path (e.g. including distance, geographical terrain, morphology, and physical obstructions such as buildings), antenna characteristics (e.g. angle of radiation and radiation polarization), potential atmospheric conditions (e.g. ionospheric conditions and the existence of meteor showers), and/or time (such as time of day of operation of the planned CBSD(s) and/or solar cycle data). The propagation models may be public and/or proprietary models. Examples of propagation models include the Hata model, the Longley-Rice model, and variations thereof. In one embodiment, the first propagation modelling system 212A-1a utilizes terrain data and/or morphology data found in the first geographic database 212A-1b and corresponding to the geographic region where propagation is modelled. Propagation models simulate path loss between a source of electromagnetic radiation, e.g. a CBSD, and another location. Data may include models. Models as used herein refer to mathematical models, e.g. used to simulate respectively transmitters, receivers, antennas and propagation. In another embodiment, the first propagation modelling system 212A-1a generates geographic contours of electromagnetic energy having the same value. In a further embodiment, such geographic contours are stored in the first parameter database 212A-2.

The first parameter database 212A-2 stores data received by the RF planning system 202 from external sources such as the SAS 104 and/or a user of the RF planning system 202, and/or data generated by the RF planning system 202. Data supplied by a user may include proposed CBSD design specifications which are exemplified below. Data supplied from the SAS 104 may include (a) design criteria data for operation of the proposed CBSD(s) that will allow the proposed CBSD(s) to work in the SAS 104 without detrimentally interfering with other CBSDs and/or incumbent user(s)' communications system(s), (b) data about other CBSDs and/or the incumbent user(s)' communications systems so that the RF planning system 202 can perform propagation analysis on the other CBSDs, the incumbent user(s)' communications systems, and/or the proposed CBSD(s), and/or (c) information about analysis performed by the SAS 104 when assisting the RF planning system perform its design function. Such data and information may include acceptable levels of interference for other CBSDs and/or incumbent user(s)' communications system(s), proposed CBSD(s)' transmitter and receiver characteristics described above, and the electromagnetic energy (or signal levels) of other CBSDs and/or incumbent user(s)' communications system(s) at one or more geographic locations. However, such data and information may include other criteria, such as other parameters specified elsewhere herein. Such criteria may be provided as ranges rather than unique values.

The RFAS modelling system 212A-1 synthesizes a design of the proposed CBSD(s) using proposed CBSD design specifications, e.g. provided by a user. The synthesized design may specify some specifications, e.g. radio component selections, number and/or geographic location(s) of proposed CBSD(s), etc., not uniquely specified in proposed CBSD design specifications, so that the CBSD design comports with the proposed design specifications, and provides sufficient information how practically deploy the system. Techniques for synthesizing radio systems are well known in the art, and are for example illustrated in U.S. Pat. No. 8,150,413 which is hereby incorporated by reference in its entirety.

The proposed CBSD design specifications may include proposed CBSD(s)' geographic location(s), proposed CBSD(s)' maximum data capacity(ies), maximum number of user equipment for each proposed CBSD, coverage zone of CBSD(s), proposed CBSD(s)' minimum detectable receive signal level(s), and/or proposed CBSD(s)' maximum transmit signal power level(s). However, the proposed CBSD design specifications may include other criteria, such as other parameters specified elsewhere herein. Such criteria may be provided as ranges rather than unique values.

The user may also specify transmitter type, receiver type, and/or antenna type, or corresponding specifications, to be used by each proposed CBSD. If the user specifies transmitter type, receiver type, and/or antenna type, the RFAS modelling system 212A-1 will obtain the corresponding specifications, e.g. from the radio database 212A-1c. In one embodiment, if the specifications are not in the radio database 212A-1c, or there is no radio database 212A-1c, then the RFAS modelling system 212A-1 will obtain the information from an external source, e.g. from the SAS 104 or the Internet.

Then, based upon specifications, e.g. received from the user, or obtained from the radio database 212A-1c or another source, the RFAS modelling system 212A-1 will determine the number and location of the CBSD(s), the height, azimuth angle and/or tilt angle of each CBSD antenna, transmit power range and frequency range of each CBSD. The RFAS modelling system 212A-1, utilizing the first propagation modelling system 212A-1a, will generate sets electromagnetic energy contours (corresponding to the transmit power ranges and operating frequency ranges) over the geographic region of the CBRS system (including the proposed CBSD), geographic regions of neighboring CBRS systems, exclusion zones, and/or protection zones. The RFAS modelling system 212A-1 may furthermore make recommendations on the type and/or requirements for fronthaul and/or backhaul communications links and/or protocols for each proposed CBSD. The RFAS modelling system 212A-1, including the first propagation modeling system 212A-1a, the first geographic database 212A-1b, and the radio database 212A-1c, and the parameter database 212A-2 are executed and/or manipulated by the first processor circuitry 212B.

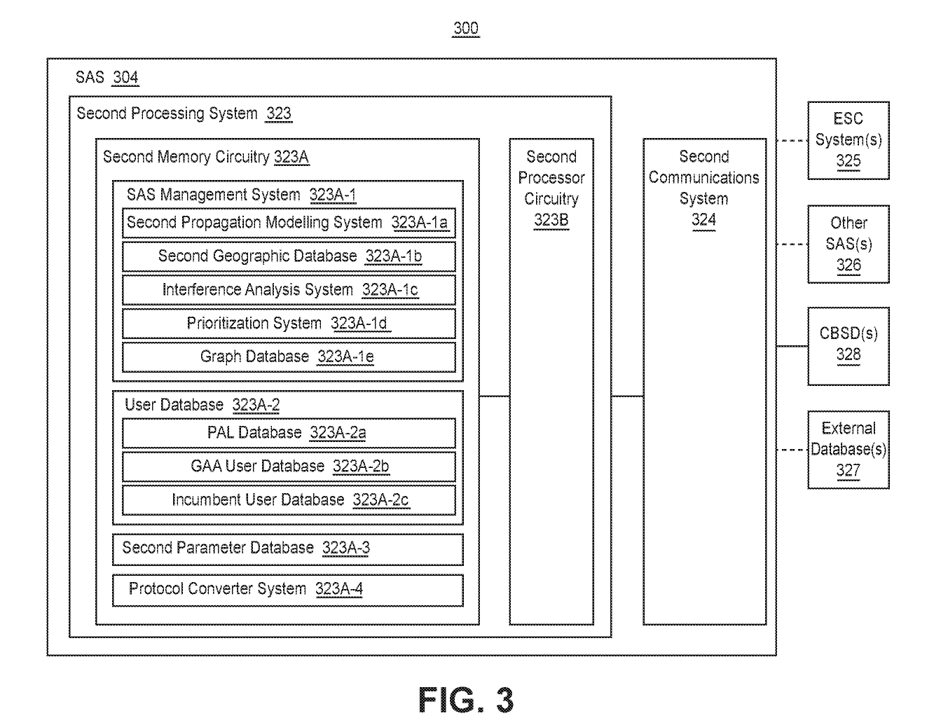

FIG. 3 illustrates one embodiment of a CBRS system 300. The illustrated CBRS system 300 includes a SAS 304 coupled to one or more CBSDs (CBSD(s)) 328. Each CBSD is operated by a GAA user and/or a PAL.

Optionally, the SAS 304 is coupled to at least one environmental sensing capability (ESC) system 325. Optionally, the CBRS system 300 is coupled to external database(s) 327, e.g. which may include information (e.g. terrain, obstacle, terrain morphology, and/or incumbent user operation data) as illustrated elsewhere herein. Optionally, the SAS 304 is coupled to at least one other SAS (other SAS(s)) 326, e.g. operating in the same or overlapping frequency spectrum as the CBRS system 300. For example, such other SAS(s) 326 and their CBSDs of their PALs and GAA users may generate electromagnetic energy that overlaps geographic region(s) of the CBRS system 300, and thus must be accounted for by the CBRS system 300 when the SAS 304 performs interference analysis, and authorizes operation of CBSD(s) 328 of the PAL(s) and/or the GAA user(s). Alternatively, the CBSD(s) 328 may generate electromagnetic energy that overlaps the geographic region(s) of the other CBRS system(s), and thus must be accounted for by the other SAS(s) when the other SAS(s) perform interference analysis. By coupling SAS(s) whose CBRS system(s) are geographically proximate to one another, each SAS can account for electromagnetic energy emitted by CBSDs of other CBRS system(s) proximate in geography.

The ESC system 325 detects, and communicates to the SAS 304, the presence of signal(s), e.g. from some incumbent user(s), such as RADARs. Alternatively, incumbent users can inform the SAS 304 that they are operating, e.g. by transmitting a signal beacon, by sending an Email notification, by providing an entry to a web page, or by communicating with the external database(s) 327 which may be coupled to the SAS 304. Upon notification of operation of an incumbent user, the SAS 304, at least in part, models the propagation of transmissions of the CBSD(s) 328 and regulates the operation (e.g. power levels and frequencies of operation) of the CBSD(s) 328 to allow the incumbent user(s)' communications system(s) to operate free of interference.

The SAS 304 otherwise controls the operation (e.g. power levels and frequencies of operation) of the GAA user(s)' communications systems so that the PAL(s)' communications system(s) operate free of interference. Further, the SAS 304 otherwise controls the operation (e.g. power levels and frequencies of operation) of GAA user(s), e.g. so each GAA user's communications system operates free of interference.

In one embodiment, the SAS 304 includes a second processing system 323 coupled to a second communications system 324. The second processing system 323 principally controls the operation of CBSD(s) 328 that form part of the CBRS system 300. However, as discussed elsewhere herein, the second processing system 323 may also assist the RF planning system 202 to design a proposed CBSD(s).

The second communications system 324 facilitates communications between the second communications system 324 and other systems, e.g. CBSDs over a communications link, the ESC system(s) 325, the RF planning system 102, the external database(s) 327, and/or other SAS(s) 326. In one embodiment, the second communications system 324 includes a modem, e.g. an Internet data modem and/or any other communications device(s) that can facilitate communications to the aforementioned systems.

In the illustrated embodiment, the second processing system 323 includes second processor circuitry 323B coupled to second memory circuitry 323A. In the illustrated embodiment, the second memory circuitry 323A includes a SAS management system 323A-1, a user database 323A-2, and a second parameter database 323A-3. In one embodiment, the user database 323A-2 includes a PAL database 323A-2a, and a GAA user database 323A-2b. Optionally, the user database 323A-2 includes an incumbent user database 323A-2c.

The PAL database 323A-2a and the GAA user database 323A-2b respectively include lists of authorized PALs and GAA user CBSDs. In one embodiment, the PAL database 323A-2a, and the GAA user database 323A-2b also include information about available and/or authorized (by the SAS 304 and with respect to time, frequency spectrum, power output level of operation, modulation types, and/or maximum tolerable interference level of each CBSD of respectively the authorized PALs and GAA users. Optionally, the PAL database 323A-2a and the GAA user database 323A-2b include the geographic location(s) of the CBSD(s) 328 of respectively the available and/or authorized PALS and GAA users' CBSDs. In another embodiment, the incumbent user database 323A-2c includes a geographic location, a coverage area (e.g. RADAR coverage area) of each incumbent user, and/or a maximum tolerable interference level of interference for each incumbent users' communications system(s) in one or more protection zones. Optionally, the PAL database 323A-2a, the GAA database user 323A-2b, and/or the incumbent user database 323A-2c includes information about:

a. corresponding transmitter operating band, maximum power level within such operating band, and/or relative out of band power levels;
b. corresponding receiver operating band and sensitivity within such operating band; and/or
c. corresponding antenna radiation patterns (including gain, radiation polarization, radiation angle, with respect to antenna height, azimuthal angle, tilt angle, and/or ground plane).

The second parameter database 323A-3 stores data received by the SAS 304 from external sources such other SAS(s) 326, CBSD(s) 328, ESC system(s) 325, external database(s) 327, and/or RF planning system 102, and/or data generated by the SAS 304. The exemplary use of data from the RF planning system 102 will be subsequently described. However, the second parameter database 323A-3, or some or all of its data, may be located elsewhere, e.g. in the SAS management system 323A-1

In one embodiment, the SAS management system 323A-1 includes a second propagation modelling system 323A-1a, an interference analysis system 323A-1c, and/or a prioritization system 323A1-d. Optionally, the SAS management system 323A-1 includes a second geographic database 323A-1b which serves a purpose analogous to the first geographic database 212a-1b. In another embodiment, the SAS management system 323A-1 includes a graph database 323A-1e. The graph database 323A-1e identifies, e.g. the location of, overlapping radiation coverage between nodes, i.e. CBSDs and/or incumbent user(s)' communications system(s). For example, such overlaps are defined as edges that connect overlapping nodes, and will be used to identify where, at least in part, propagation and/or spectrum analysis should be performed. Optionally, the second memory circuitry 323A includes a protocol converter system 323A-4 which facilitates communications between the SAS 304, and CBSD(s) 328 and other SAS(s) 326, e.g. using respectively the Wireless Innovation Forum's SAS to CBSD and SAS to SAS protocols. Optionally, the SAS management system 323A-1 includes a prioritization system 323A-1d which may be used to prioritize CBSD operation of GAA user(s) and/or PAL(s) (over other GAA user(s)' and/or other PAL(s)' CBSD operation, e.g. based upon the amount of money that GAA users and/or PAL's are willing to pay or have previously paid to obtain such priority or rules regarding fairness of frequency spectrum use. The SAS management system 323A-1, the user database 323A-2, the second parameter database 323A-3, and the protocol converter system 323A-4 are executed or manipulated by the second processor circuitry 323B.

The SAS management system 323A-1 will now be described in more detail. The SAS management system 323A-1 determines whether a PAL or GAA user CBSD (prospective CBSD) can operate, e.g. in response to a request respectively from the PAL or GAA user CBSD. The SAS management system 323A-1 determines whether incumbent user(s)' communications system(s) are operating, e.g. based upon information from (a) the ESC system(s) 325, (b) signal beacons, and/or (c) synchronization of the user database 323A-2 (such as the incumbent user database 323A-2c) with external database(s) 327 (such as an FCC database), and, using propagation modelling, whether operation of the prospective CBSD would cause incumbent user(s)' communications system(s), and authorized PAL(s)' and/or GAA user(s)' CBSDs (already authorized by the SAS 304 to transmit) to be free of interference in the shared frequency spectrum. To do so, the SAS management system 323A-1 estimates, using the second propagation modeling system 323A-1a, the electromagnetic energy generated by operational incumbent user(s)' communications system(s), and authorized CBSDs and the prospective CBSD in the CBRS system 300. In one embodiment, the electromagnetic energy of incumbent user(s)' communications system(s) and/or CBSDs proximate to the CBRS system 300, but not part of the CBRS system 300, are also modeled.

The second propagation modelling system 323A-1a estimates electromagnetic energy radiated by such incumbent user communications systems and CBSDs over geographic region(s) and/or at discrete location(s). The second propagation modelling system 323A-1a includes one or more RF propagation models, which describe path loss, over geographic region(s) and/or at discrete location(s), of a combination of a transmitter and antenna(s), of a CBSD or incumbent user communications system, for different propagation conditions. The selection of a propagation model depends upon frequency spectrum, the propagation path (e.g. including distance, morphology, geographical terrain, and physical obstructions such as buildings), antenna characteristics (e.g. angle of radiation and radiation polarization), potential atmospheric conditions (e.g. ionospheric conditions and the existence of meteor showers), and/or time (such as time of day and/or solar cycle). The propagation models may be public and/or proprietary models. Examples of propagation models include the Hata model, the Longley-Rice model, and variations thereof. In one embodiment, the second propagation modelling system 323A-1a utilizes terrain data and morphology data found in the second geographic database 323A-1b and corresponding to the geographic region where propagation is modelled. In another embodiment, the second propagation modelling system 323A-1a includes a single propagation model. In a further embodiment, the second propagation modelling system 323A-1a generates geographic contours of electromagnetic energy having the same value. In yet another embodiment, such geographic contours are stored in the second parameter database 323A-3.

After propagation modelling, the interference analysis system 323A-1c determines whether the additional electromagnetic energy contributed by the prospective CBSD causes an incumbent user communications system or CBSD associated with the SAS 304 to not be free of interference. For example, this is performed by determining if the aggregate electromagnetic energy level (including the additional electromagnetic energy contributed by the prospective CBSD) proximate to, and in or about the operating frequency of, each such CBSD and incumbent user communications system exceeds the specified maximum tolerable interference level of each such system.

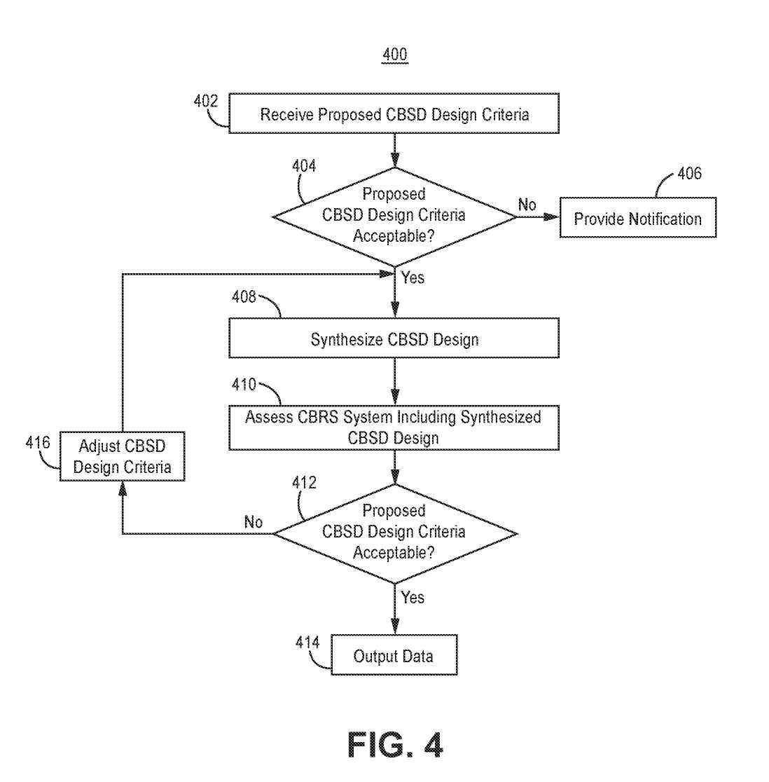

FIG. 4 illustrates one embodiment of a method of cooperative operation of the RF planning system and the SAS (method) 400. To the extent the method 400 shown in FIG. 4 is described herein as being implemented in the systems shown in FIGS. 1A through 3, it is to be understood that other embodiments can be implemented in other ways. The blocks of the flow diagrams have been arranged in a generally sequential manner for ease of explanation; however, it is to be understood that this arrangement is merely exemplary, and it should be recognized that the processing associated with the methods (and the blocks shown in the Figures) can occur in a different order (for example, where at least some of the processing associated with the blocks is performed in parallel and/or in an event-driven manner).

In block 402, receive, e.g. at the RF planning system 102, preliminary design criteria for the proposed CBSD. In one embodiment, the preliminary design criteria include, preferred sets, or ranges, of geographic coverage area(s), data capacity (e.g. of each CBSD), number of users (e.g. of each CBSD), potential operating times, operating frequency spectrum, operating power output levels (e.g. of each CBSD), operating modulation types (e.g. corresponding to different data rates), antenna azimuthal and tilt angles, receiver sensitivity, and/or maximum tolerable interference criteria. In another embodiment, such preliminary design criteria include equipment specifications, for example, receiver type, transmitter type, and antenna type. In a further embodiment, the preliminary design criteria are submitted by a user, e.g. to the RF planning system 102, or provided by the SAS 104; for example, the user can enter the data into the at least one I/O 213. In yet another embodiment, receive sets, or ranges, of corresponding to the maximum ranges of the aforementioned criteria. Such sets of maximum ranges of criteria are supersets of respective preliminary design criteria sets; in other words, the preliminary design criteria sets are sub-sets of respective sets of maximum ranges. As will be subsequently described, the RF planning system 102 and/or the SAS 104 can adjust the preliminary criteria, if need be so that parameters can fall within the ranges of the supersets. In yet a further embodiment, some or all of the preliminary design criteria sets and/or sets of maximum ranges are provided by a user, and/or from a database, e.g. the radio database 212A-4 based upon an identification of the corresponding equipment. In one embodiment, the aforementioned sets of data are stored in the first parameter database 212A-2.

In one embodiment, in block 404, assess whether the proposed CBSD design, based upon proposed geographic and technical information of the proposed CBSD design, is acceptable. In another embodiment, the RF planning system 202 provides to the SAS 304 the proposed location and maximum ranges of technical operating parameters, such as power and frequency. In further embodiment, the SAS management system 323A-1 determines whether the proposed design is acceptable. For example, the SAS management system 323A-1 will determine if the location of the proposed CBSD design is acceptable, e.g. does not fall within an exclusion zone where no CBSD operation is allowed. Further, for example, the SAS management system 323A-1 will determine if the proposed operating frequency range falls within the frequency spectrum controlled by the SAS. Based upon such analysis, e.g., the SAS 304 notifies the RF planning system 202 if the proposed CBSD design is acceptable. If the CBRS system, e.g. the SAS, notifies the RF planning system that the proposed CBSD design is unacceptable, then in block 406 RF planning system 202 ceases further analysis and provides notification to the user (e.g. person or system) of the reasons why this decision was made, e.g. due to location or operating frequency. In yet another embodiment, the notification can be provided through the at least one I/O 213.

In block 408, synthesize the proposed CBSD design, e.g. a network of CBSDs such as base stations, using the sets of preliminary design criteria. In one embodiment, the number and location(s) of the proposed CBSD(s) are synthesized. In one embodiment, synthesize the design using the RFAS modeling system 212A-1, as described above, of the RF planning system 202.

In block 410, assess the CBRS system including the synthesized CBSD design, e.g. to determine if other CBSDs of the CBRS system will be free of interference during operation of the proposed CBSD, and/or if the proposed CBSD will be free of interference during its operation; perform such interference assessment using CBRS system data and data about the synthesized CBSD design. Such CBRS system data may include data generated by the SAS management system 323A-1, and stored in the user database 323A-2 and/or second parameter database 323A-3. In one embodiment, as described above, utilize the SAS management system 323A-1, e.g. the second propagation modelling system 323A-1a, the second geographic database 323A-1, the interference analysis system 323A-1c, and/or the graph database 323A-1e to perform such analysis. Alternatively perform some or all of the analysis using the RF planning system 202, e.g. using the first propagation modelling system 212A-1a. Optionally, perform the performance analysis, e.g. using Monte Carlo analysis using the range of design criteria of the proposed CBSD(s) and a range of operating parameters of (a) each of the incumbent user(s)' communications system(s) geographically proximate to the CBRS system 300, and/or the (b) CBSD(s) 328 of the CBRS system 300, to determine the geographical distribution of electromagnetic energy of each of such communications systems.

Optionally, perform the propagation modelling in the RFAS modelling system 212A-1 of the RF planning system 202, rather than in the SAS management system 323A-1. Therefore, provide information about relevant incumbent user communications systems, and PAL and GAA user CBSDs from the SAS 304 to the RFAS modelling system 212A-1. In one embodiment, obtain relevant data from the graph database 323A-1e of the SAS 304 to identify which nodes in the graph database 323A-q propagation and/or interference modelling should be performed. Then, use the first propagation modelling system 212A-1 and the first geographic database 212A-1b to model the propagation of the relevant incumbent user communications systems, and

PAL and GAA user CBSDs, and the proposed CBSD(s). Optionally, the forgoing analysis is performed with the aforementioned Monte Carlo analysis.

Finally, communicate the results, e.g. geographic electromagnetic energy contours, to SAS management system 323A-1, so that the interference analysis system 323A-1c can determine if other components of the SAS 304 will be free of interference during operation of the proposed CBSD(s), and/or if the proposed CBSD(s) will be free of interference during their operation. If Monte Carlo analysis is used, multiple results are communicated to the interference analysis system 323A-1c, which correspondingly generates multiple analyses. In one embodiment, identify the sets of design criteria used in the Monte Carlo analysis that give rise to interference free operation of the SAS 304 and the synthesized CBSD design.

In block 412, determine if the proposed design criteria of the proposed CBSD(s) are acceptable, e.g. based upon interference analysis described above and/or geographic location of the proposed CBSD(s). In one embodiment, determine if the proposed design criteria (or a sub-set of the proposed design criteria if Monte Carlo analysis is used) of the synthesized CBSD design permits (1) satisfactory operation of the CBSD(s), e.g. determined by analyzing the synthesized CBSD design with the subset of design criteria, e.g. using the RFAS modelling system 212A-1 of the RF planning system 202, components (incumbent user(s)' communications systems, and PAL(s)' and GAA user(s)' CBSDs) of the SAS 304 will be free of interference during operation of the synthesized CBSD design, and/or the synthesized CBSD design will be free of interference during its operation.

If the proposed design criteria of the proposed CBSD(s) are acceptable, then in block 414 output the proposed design criteria (data) so that it can be provided to the user (a person or system), e.g. using the at least one I/O 213. If the proposed design criteria of the proposed CBSD(s) are not acceptable, then in block 416, adjust the previously analyzed set of design criteria within the sets of maximum ranges of design criteria. Optionally, to avoid an infinite processing loop, a counter can be implemented to count the number of times that the CBSD design criteria are adjusted and the CBSD design is synthesized. If the counter exceeds a threshold number, e.g. defined by the RF planning system 202 or a user, then the method 400 is terminated and indicates, e.g. to the user and/or another system, that no acceptable CBSD design criteria could be determined. In one embodiment, expand the upper and lower ranges of each set of design criteria by a percentage, such as ten percent, e.g. entered by the user or RF planning system designer. Such percentage, for example, may be stored in the first parameter database 212A-2. In one embodiment, if proposed CBSD design criteria comprise more than one CBSD, then the design criteria may be uniquely changed for each CBSD. For example, proposed CBSD(s) closer to exclusion zones, incumbent user communications systems, and/or other CBSD(s) may have their transmit power levels reduce relative to the other proposed CBSD. After performing the adjustment, return to block 408.

The processor circuitry described herein may include one or more microprocessors, microcontrollers, digital signal processing (DSP) elements, application-specific integrated circuits (ASICs), and/or field programmable gate arrays (FPGAs). In this exemplary embodiment, processor circuitry includes or functions with software programs, firmware, or other computer readable instructions for carrying out various process tasks, calculations, and control functions, used in the methods described herein. These instructions are typically tangibly embodied on any storage media (or computer readable medium) used for storage of computer readable instructions or data structures.

The memory circuitry described herein can be implemented with any available storage media (or computer readable medium) that can be accessed by a general purpose or special purpose computer or processor, or any programmable logic device. Suitable computer readable medium may include storage or memory media such as semiconductor, magnetic, and/or optical media. For example, computer readable media may include conventional hard disks, Compact Disk-Read Only Memory (CD-ROM), DVDs, volatile or non-volatile media such as Random Access Memory (RAM) (including, but not limited to, Dynamic Random Access Memory (DRAM)), Read Only Memory (ROM), Electrically Erasable Programmable ROM (EEPROM), and/or flash memory. Combinations of the above are also included within the scope of computer readable media.

Methods of the invention can be implemented in computer readable instructions, such as program modules or applications, which may be stored in the computer readable medium and executed by the processor circuitry. Generally, program modules or applications include routines, programs, objects, data components, data structures, algorithms, and the like, which perform particular tasks or implement particular abstract data types.

Databases as used herein may be either conventional databases or data storage formats of any type, e.g. data files. Although separate databases are recited herein, one or more of such databases may be combined.

### Exemplary Embodiments

Example 1 includes a system, comprising: a radio frequency (RF) planning system, comprising: a first processing system; a first communications system coupled to the first processing system; at least one input/output device coupled to the first processing system; wherein the first processing system comprises first memory circuitry and first processor circuitry; and wherein the first processing system is configured to: receive proposed RF access system design criteria; synthesize an RF access system design; assess interference using shared spectrum system data and data about the synthesized RF access system design; determine if the proposed RF access system design criteria are acceptable based upon the interference assessment; and if the proposed RF access system design criteria are unacceptable, then adjust the proposed RF access system design criteria.

Example 2 includes the system of Example 1, wherein the first memory circuitry comprises a radio frequency (RF) access system modeling system; and wherein the RFAS modelling system comprises a first propagation modelling system and a first geographic database.

Example 3 includes the system of Example 2, wherein the RFAS modelling system further comprises a radio database.

Example 4 includes the system of any of Examples 1-3, wherein the first memory comprises a first parameter database.

Example 5 includes the system of any of Examples 1-4, further comprising a shared spectrum system coupled to the RF planning system.

Example 6 includes the system of Example 5, wherein shared spectrum system comprises at least one RF access system coupled to a spectrum access system (SAS).

Example 7 includes the system of Example 6 wherein the shared access system is further coupled to at least one of (a) at least one other SAS, and (b) at least one environmental sensing capability (ESC) system.

Example 8 includes the system of any of Examples 6-7, wherein the SAS comprises: a second processing system; and a second communications system coupled to the second processing system.

Example 9 includes the system of Example 8, wherein the second processing system comprises: second processor circuitry; and second memory circuitry coupled to the second processor circuitry.

Example 10 includes the system of Example 9, wherein the second memory circuitry comprises: a SAS management system; and a user database.

Example 11 includes the system of any of Examples 9-10, wherein the second memory circuitry comprises at least one of a second parameter database and a protocol converter system.

Example 12 includes the system of any of Examples 10-11, wherein the SAS management system comprises: a second propagation modeling system; a second geographic database; and an interferences analysis system.

Example 13 includes the system of any of Examples 10-12, wherein the SAS management system further comprises a prioritization system.

Example 14 includes the system of any of Examples 10-13, wherein the SAS management system further comprises a graph database.

Example 15 includes the system of any of Examples 1-14, wherein the first processing system is further configured to perform at least one of: (a) output the proposed RF access system design criteria if the proposed RF access system design criteria are acceptable; and (b) terminate the design if the proposed RF access system design criteria are unacceptable.

Example 16 includes a method of designing at least one proposed radio frequency (RF) access system for inclusion in a shared spectrum system, comprising: receiving proposed RF access system design criteria; synthesizing an RF access system design; assessing interference using shared spectrum system data and data about the synthesized RF access system design; determining if the proposed RF access system design criteria are acceptable based upon the interference assessment; and if the proposed RF access system design criteria are unacceptable, then adjusting the proposed RF access system design criteria.

Example 17 includes the method of Example 16, further comprising if the proposed RF access system design criteria are acceptable, then outputting the proposed RF access system design criteria.

Example 18 includes the method of any of Examples 16-17, further comprising at least one of: wherein determining if proposed RF access system design criteria are acceptable comprises determining whether design criteria are acceptable also based upon geographical location of the at least one proposed RF access system; and if the proposed RF access system design criteria are unacceptable, then terminating the design.

Example 19 includes a non-transitory computer readable medium storing a program causing a computer to execute a process for designing at least one proposed RF access system for inclusion in a shared spectrum system, the process comprising: receiving proposed RF access system design criteria; synthesizing an RF access system design; assessing interference using shared spectrum system data and data about the synthesized RF access system design; determining if the proposed RF access system design criteria are acceptable based upon the interference assessment; and if the proposed RF access system design criteria are unacceptable, then adjusting the proposed RF access system design criteria.

Example 20 includes the non-transitory computer readable medium of Example 19, wherein the process further comprises if the proposed RF access system design criteria are acceptable, then outputting the proposed RF access system design criteria.

Example 21 includes the non-transitory computer readable medium of any of Examples 19-20, wherein the process further comprises at least one of: wherein determining if proposed RF access system design criteria are acceptable comprises determining whether design criteria are acceptable also based upon geographical location of the at least one proposed RF access system; and if the proposed RF access system design criteria are unacceptable, then terminating the design.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

1. A system, comprising:
a radio frequency (RF) planning system, comprising:
a first processing system;
a first communications system coupled to the first processing system;
at least one input/output device coupled to the first processing system;
wherein the first processing system comprises first memory circuitry and first processor circuitry; and
wherein the first processing system is configured to:
receive proposed RF access system design criteria;
synthesize an RF access system design;
assess interference using shared spectrum system data and data about the synthesized RF access system design;
determine if the proposed RF access system design criteria are acceptable based upon the interference assessment; and
if the proposed RF access system design criteria are unacceptable, then adjust the proposed RF access system design criteria.

2. The system of claim 1, wherein the first memory circuitry comprises a radio frequency (RF) access system modeling system; and
wherein the RFAS modelling system comprises a first propagation modelling system and a first geographic database.

3. The system of claim 2, wherein the RFAS modelling system further comprises a radio database.

4. The system of claim 1, wherein the first memory comprises a first parameter database.

5. The system of claim 1, further comprising a shared spectrum system coupled to the RF planning system.

6. The system of claim 5, wherein shared spectrum system comprises at least one RF access system coupled to a spectrum access system (SAS).

7. The system of claim 6 wherein the shared access system is further coupled to at least one of (a) at least one other SAS, and (b) at least one environmental sensing capability (ESC) system.

8. The system of claim 6, wherein the SAS comprises:
a second processing system; and
a second communications system coupled to the second processing system.

9. The system of claim 8, wherein the second processing system comprises:
second processor circuitry; and
second memory circuitry coupled to the second processor circuitry.

10. The system of claim 9, wherein the second memory circuitry comprises:
a SAS management system; and
a user database.

11. The system of claim 9, wherein the second memory circuitry comprises at least one of a second parameter database and a protocol converter system.

12. The system of claim 10, wherein the SAS management system comprises:
a second propagation modeling system;
a second geographic database; and
an interferences analysis system.

13. The system of claim 10, wherein the SAS management system further comprises a prioritization system.

14. The system of claim 10, wherein the SAS management system further comprises a graph database.

15. The system of claim 1, wherein the first processing system is further configured to perform at least one of: (a) output the proposed RF access system design criteria if the proposed RF access system design criteria are acceptable; and (b) terminate the design if the proposed RF access system design criteria are unacceptable.

16. A method of designing at least one proposed radio frequency (RF) access system for inclusion in a shared spectrum system, comprising:
receiving proposed RF access system design criteria;
synthesizing an RF access system design;
assessing interference using shared spectrum system data and data about the synthesized RF access system design;
determining if the proposed RF access system design criteria are acceptable based upon the interference assessment; and
if the proposed RF access system design criteria are unacceptable, then adjusting the proposed RF access system design criteria.

17. The method of claim 16, further comprising if the proposed RF access system design criteria are acceptable, then outputting the proposed RF access system design criteria.

18. The method of claim 16, further comprising at least one of:
wherein determining if proposed RF access system design criteria are acceptable comprises determining whether design criteria are acceptable also based upon geographical location of the at least one proposed RF access system; and
if the proposed RF access system design criteria are unacceptable, then terminating the design.

19. A non-transitory computer readable medium storing a program causing a computer to execute a process for designing at least one proposed RF access system for inclusion in a shared spectrum system, the process comprising:
receiving proposed RF access system design criteria;
synthesizing an RF access system design;
assessing interference using shared spectrum system data and data about the synthesized RF access system design;
determining if the proposed RF access system design criteria are acceptable based upon the interference assessment; and
if the proposed RF access system design criteria are unacceptable, then adjusting the proposed RF access system design criteria.

20. The non-transitory computer readable medium of claim 19, wherein the process further comprises if the proposed RF access system design criteria are acceptable, then outputting the proposed RF access system design criteria.

21. The non-transitory computer readable medium of claim 19, wherein the process further comprises at least one of:
wherein determining if proposed RF access system design criteria are acceptable comprises determining whether design criteria are acceptable also based upon geographical location of the at least one proposed RF access system; and
if the proposed RF access system design criteria are unacceptable, then terminating the design.
